(19) United States
(12) Patent Application Publication
(10) Pub. No.: US 2018/0029451 A1
(43) Pub. Date: Feb. 1, 2018

(54) Multifunction Accessory for an Electronic Device

(71) Applicants: John N. Brewster, Kingwood, TX (US); Drew A. Brewster, Madisonville, LA (US)

(72) Inventors: John N. Brewster, Kingwood, TX (US); Drew A. Brewster, Madisonville, LA (US)

(21) Appl. No.: 15/581,077

(22) Filed: Apr. 28, 2017

Related U.S. Application Data
(60) Provisional application No. 62/368,347, filed on Jul. 29, 2016.

(51) Int. Cl. A24F 15/00; F21V 1/06; F21V 1/00; B60J 3/02; F21V 5/00; B65D 85/10

(52) U.S. Cl. CPC B60J 3/0217; F21V 1/06; F21V 5/002; F21S 48/125

(57) ABSTRACT

A multifunction accessory for an electronic device is provided. The multifunction accessory may include a back member, a shade member, a mirror, a plurality of support members, and a plurality of brackets. A hinge mechanism may connect the back member to the shade member and hinges may connect the shade member and support members. The mirror may be coupled to the shade member. The brackets may be coupled to the back member and the support members may be removably coupled to the brackets.

### CROSS-REFERENCE TO RELATED APPLICATIONS

This application claims the benefit of U.S. Provisional Patent Application having Ser. No. 62/368,347, which was filed Jul. 29, 2016. The aforementioned patent application is hereby incorporated by reference in its entirety into the present application to the extent consistent with the present application.

### BACKGROUND

Electronic devices are frequently used outdoors or in areas with direct lighting. The sunlight or direct lighting in these areas can be reflected by a display on the electronic device, making the display difficult to read. Additionally, electronic devices are often used in public places. The large displays available on some electronic devices may allow others to view the display.

What is needed, therefore, is a way to reduce the amount of sunlight or direct light that reaches the display, thereby reducing the amount of light reflected by the display, and making the display easier to read, while also shielding the display from public viewing.

### SUMMARY

Embodiments of the disclosure may provide a multifunction accessory for an electronic device. The multifunction accessory may include a back member defining an aperture, a first side bracket coupled to the back member, and a second side bracket coupled to the back member and positioned opposite the first side bracket. A hinge mechanism may be connected to the back member between the first and second side brackets. The multifunction accessory may further include a shade member coupled to the hinge mechanism opposite the back member connection, a first hinge connected to a first side of the shade member, and a second hinge connected to a second side of the shade member and positioned opposite the first hinge. A first support member may be coupled to the first hinge opposite the shade member connection and removably coupled to the first side bracket, and a second support member may be coupled to the second hinge opposite the shade member connection and removably coupled to the second side bracket.

Embodiments of the disclosure may further provide another multifunction accessory for an electronic device. The multifunction accessory may include a single body. The single body may include a back member defining an aperture and having a first and second side, a first side bracket extending from the first side of the back member, a second side bracket extending from the second side of the back member and opposite the first side bracket, and a shade member extending from the back member between the first side bracket and the second side bracket. A first hinge may be formed between the back member and the shade member. The multifunction accessory may further include a first support member extending from the shade member and removably coupled to the first side bracket, and a second support member extending from the shade member opposite the first support member and removably coupled to the second side bracket. A second hinge may be formed between the shade member and the first support member, and a third hinge may be formed between the shade member and the second support member.

Embodiments of the disclosure may further provide another multifunction accessory for an electronic device. The multifunction accessory may include a back member defining an aperture, a plurality of pins extending from the back member, and a hinge mechanism connected to the back member. The multifunction accessory may further include a shade member coupled to the hinge mechanism opposite the back member connection, a first hinge connected to a first side of the shade member, and a second hinge connected to a second side of the shade member and positioned opposite the first hinge. A first support member may be coupled to the first hinge opposite the shade member connection and removably coupled to at least a first pin of the plurality of pins, and a second support member may be coupled to the second hinge opposite the shade member connection and removably coupled to at least a second pin of the plurality of pins.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1A illustrates an isometric view of a front of a multifunction accessory for an electronic device, according to one or more embodiments disclosed.

FIG. 1B illustrates a side view of the multifunction accessory for an electronic device of FIG. 1A.

FIG. 2 illustrates an isometric view of a front of a multifunction accessory for an electronic device, according to one or more embodiments disclosed.

FIG. 3 illustrates an isometric view of a back of a multifunction accessory for an electronic device, according to one or more embodiments disclosed.

FIG. 4 illustrates an isometric view of a multifunction accessory for an electronic device folded for storage, according to one or more embodiments.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

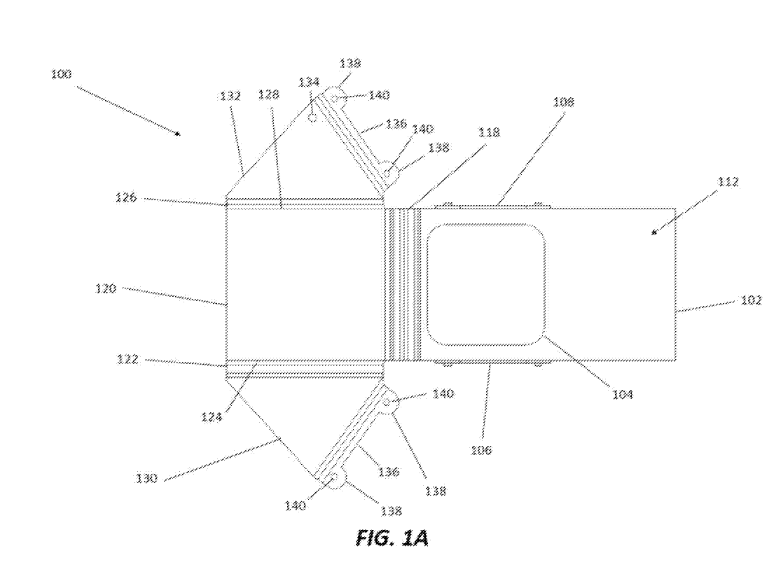

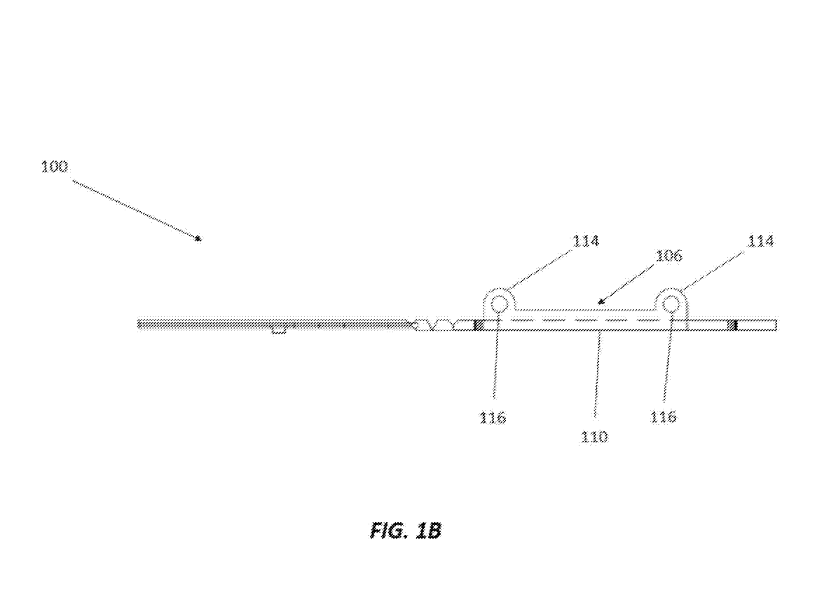

FIG. 1A illustrates an isometric view of a front of a multifunction accessory 100 for an electronic device (not shown), according to one or more embodiments. In the exemplary embodiment, the multifunction accessory 100 may include a generally rectangular back member 102 defining an aperture 104. The aperture 104 may be rectangular in shape and sized to allow the back member 102 to attach to the back of an electronic device without interfering with any features, such as buttons, keys, cameras, or screens, on the surface of the electronic device. In other embodiments, the back member 102 and/or aperture 104 may be circular, oval, polygonal, or any other shape that allows the back member 102 to attach to an electronic device without interfering with the surface features of the electronic device.

The multifunction accessory 100 may include a first side bracket 106 and a second side bracket 108 coupled to either side of the back member 102. The brackets 106, 108 may be coupled to the back member 102 by adhering, welding, or integrally forming the brackets 106, 108 with the back member 102. Referring to FIG. 1B, each bracket 106, 108 may include a rectangular body 110 that is generally perpendicular to a face 112 of the back member 102. In another embodiment, the body 110 may be circular, oval, or polygonal in shape. In the exemplary embodiment, the side brackets 106, 108 further include a plurality of arcuate pin supports 114 that extend from the brackets 106, 108.

In other embodiments, the pin supports 114 may be polygonal or a combination of arcuate and polygonal segments. Each pin support 114 may be formed from the side brackets 106, 108. In at least one embodiment, the pin supports 114 may be directly coupled to the back member 102 using the previously stated methods or formed from the back member 102, omitting the rectangular bodies 110. As illustrated in the exemplary embodiment, each pin support 114 may include a pin 116 extending away from the back member 102. In other embodiments, the pin support 114 may be omitted and the pin 116 may extend from the bodies 110 of the side brackets 106, 108.

Referring back to FIG. 1A, the multifunction accessory 100 may further include a hinge mechanism 118 that connects the back member 102 to a shade member 120. The shade member 120 may be rectangular, as illustrated in FIG. 1A. Other embodiments of the shade member 120 may polygonal, arcuate, or any other shape that can be attached to the hinge mechanism 118. The hinge mechanism 118 may be connected to the back member 102 and the shade member 120 using adhesives, welding, or integrally forming the hinge mechanism 118 with the back member 102 and shade member 120.

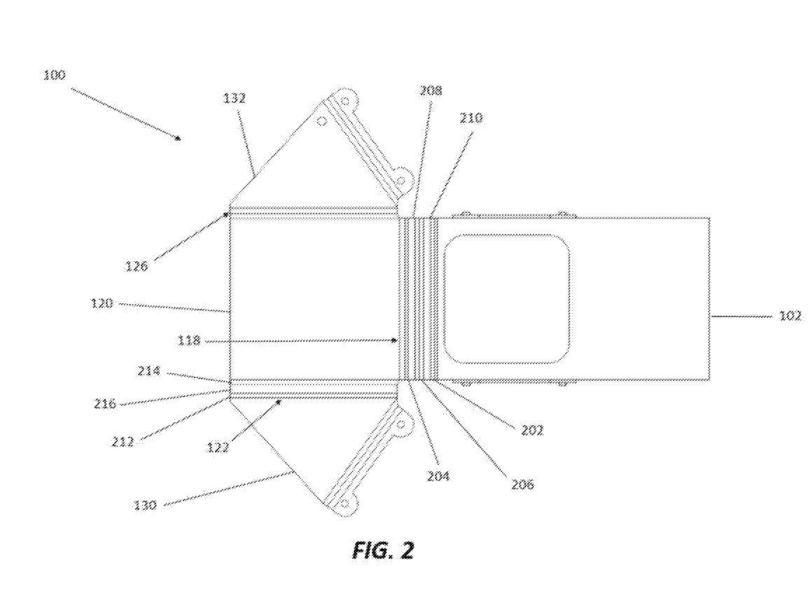

Referring now to FIG. 2 with continued reference to FIGS. 1A and 1B, the hinge mechanism 118 may include three pivots 202, 204, 206 and two spacers 208, 210. The length of the spacers 208, 210 may vary to allow embodiments of the multifunction accessory 100 to be used with a variety of electronic devices with varying thicknesses. One pivot 202 may be coupled to the back member 102, while another pivot 204 may be coupled to the shade member 120. A third pivot 206 may separate the two spacers 208, 210. Other embodiments of the hinge mechanism 118 may include two or more pivots and one or more spacers.

Referring back to FIG. 1A, the multifunction accessory 100 may further include a first hinge 122 connected to a first side 124 of the shade member 120 and a second hinge 126 connected to a second side 128 of the shade member 120 opposite the first hinge 122. The first hinge 122 may be further coupled to a first support member 130 opposite the connection to the shade member 120. The second hinge 126 may be further coupled to a second support member 132 opposite the connection to the shade member 120. The hinges 122, 126 may be coupled to the shade member 120 and support members 130, 132 using adhesives, welding, or integrally forming the hinges 122, 126 with the shade member 120 and support members 130, 132.

As shown in FIG. 2, one or both of the hinges 122, 126 may include two pivots 212, 214 and a spacer 216 between the shade member 120 and the respective support member 130, 132. At least one embodiment may include only one pivot and omit the spacer 216. Other embodiments may include at least three pivots and at least two spacers.

The support members 130, 132 may be generally triangular in shape. However, other embodiments of the multifunction accessory 100 may include support members 130, 132 that are arcuate, polygonal, or any other shape that can be connected to the hinge 122, 126. Referring back to FIG. 1A, the second support member 132 may define a hole 134 near the edge opposite the hinge 126. Each support member 130, 132 may also include a rectangular member 136 coupled to the support members 130, 132 using adhesives, welding, or integrally forming the rectangular member 136 with the support member 130,132.

As illustrated in the exemplary embodiment, the rectangular member 136 may have one or more arcuate sections 138 which extend away from the support member 130, 132 and define a hole 140. In at least one embodiment, the arcuate sections 138 may be directly coupled to the support members 130, 132 using the previously stated methods or formed from the support members 130, 132. In other embodiments, the sections 138 may be polygonal in shape or the arcuate sections 138 may be omitted.

The multifunction accessory 100 may also include a plurality of cut-outs (not shown) near the hinge mechanism 118. The cut-outs may extend through the multifunction accessory 100 across portions of the support members 130, 132, hinges 122, 126, and shade member 120. In at least one embodiment, the cut-outs may be arcuate in shape. In other embodiments, the cut-outs may be polygonal or a combination of arcuate and polygonal segments.

The multifunction accessory 100 may be constructed from multiple individual members, as described above, or the multifunction accessory 100 may be molded or cast as a single body that has the features described above. Other embodiments of the multifunction accessory 100 may be constructed using a combination of molded or cast sections, each molded section including at least one of the features described above. In one particular embodiment, the multifunction accessory 100 may be manufactured by injection molding to create a single body with the shade member 120 extending from the back member 102, and the support members 130,132 extending from the shade member 120. The single body may then be crimped to create the hinge mechanism 118 and hinges 122, 126.

The multifunction accessory 100 is referred to as a “shade” because one functionality for the multifunction accessory 100 is to shade the screen of an electronic device in the presence of strong light. This should aid visibility of the screen's content. However, the multifunction accessory 100 can provide other functionality as well. For example, even in environments without light, the multifunction accessory 100 can be used to shade the screen from people other than the user and thereby provide privacy to the content displayed on the screen. Other functionalities may become apparent to those ordinarily skilled in the art having the benefit of this disclosure. Accordingly, applications for the multifunction accessory 100 are not limited to those in which the multifunction accessory 100 shades an electronic device's screen from light.

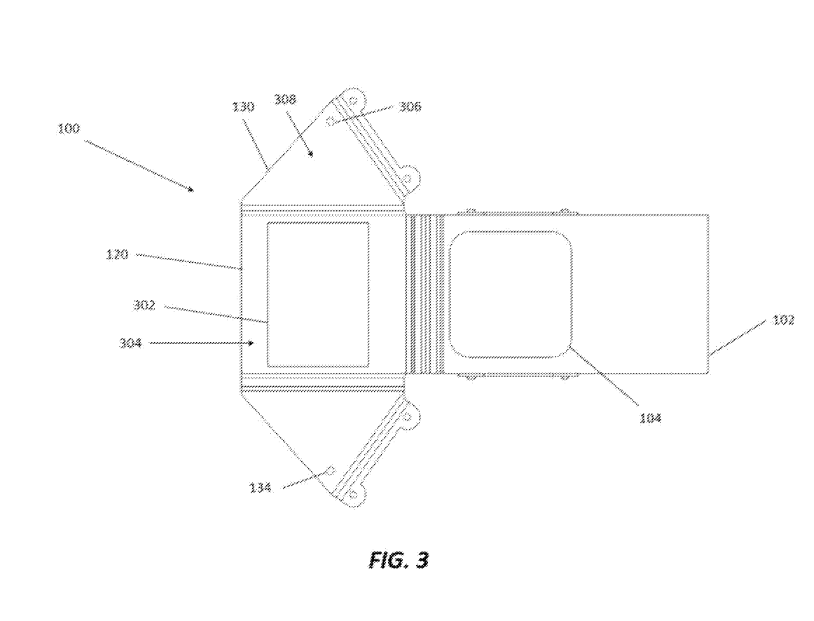

Referring now to FIG. 3 with continued reference to FIGS. 1A, 1B, and 2, FIG. 3 illustrates an isometric view of a back of the multifunction accessory 100 for an electronic device, according to one or more embodiments disclosed. In the exemplary embodiment, a mirror 302 is coupled to a back 304 of the shade member 120. The mirror 302 may be similar in shape to, but slightly smaller than the aperture 104 of the back member 102. Other embodiments of the multifunction accessory 100 may include a mirror 302 that is a different shape that the aperture 104 or the mirror 302 may be omitted. The multifunction accessory 100 may further include a pin 306 extending from a back face 308 of the first support member 130.

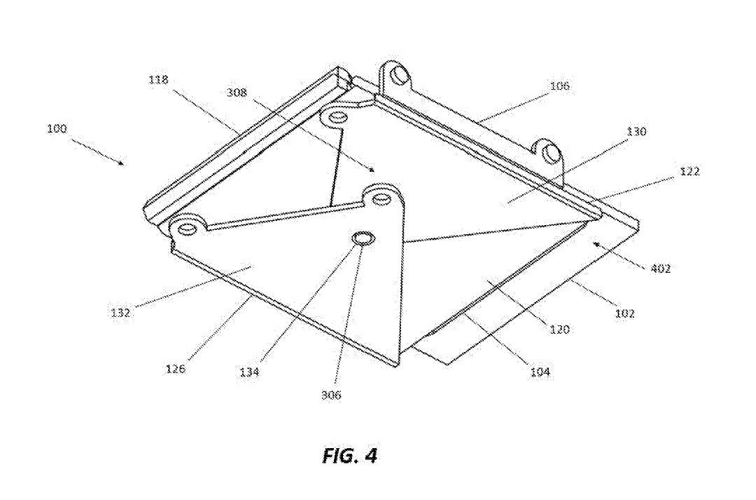

FIG. 4 illustrates an isometric view of the multifunction accessory 100 for an electronic device folded for storage, according to one or more embodiments. The exemplary embodiment in FIG. 4 may be best understood with continued reference to FIGS. 1A, 1B, 2, and 3. As shown in FIG. 4, the shade member 120 may fold along the hinge mechanism 118 such that it contacts the back 402 of the back member 102. The mirror 302 may be disposed within the aperture 104 of the back member 102 when the multifunction accessory 100 is folded for storage.

The first support member 130 may fold along the first hinge 122 such that the first support member 130 contacts the shade member 120 and the pin 306 on the back face 308 of the first support member 130 extends away from the shade member 120. In at least one embodiment, a cut-out (not shown) in the shade member 120, first hinge 122, and first support member 130 may be configured to allow the first support member 130 to pass over the pin support 114 of the first bracket 106. The second support member 132 may fold along the second hinge 126 such that the second support member 132 contacts the first support member 130. The hole 134 defined by the second support member 132 may be configured to align with the pin 306 extending from the first support member 130. The pin 306 may be sized such that it fits within the hole 134 and removably couples the first support member 130 to the second support member 132 through a snap fit. As with the first bracket 106, a cut-out (not shown) in the shade member 120, second hinge 126, and second support member 132 may allow the second support member 132 to pass over the pin support 114 of the second bracket 108.

In at least one embodiment, the pin 306 extending from the first support member 130 and the hole 134 defined by the second support member 132 may be replaced by a plurality of magnets that removably couple the first support member 130 and second support member 132. Other embodiments of the multifunction accessory 100 may use adhesives, Velcro, or any other means of removably coupling the first support member 130 and the second support member 132.

In operation, the back member 102 may be coupled to an electronic device (not shown) such that the back of the electronic device contacts the face 112 of the back member 102. The back member 102 may be coupled to the electronic device through adhesives, Velcro, portions of the back member 102 or brackets 106, 108 that grip the electronic device, or any other means of coupling the back member 102 to the electronic device, none of which are shown.

In the exemplary embodiment, the hinge mechanism 118 allows the shade member 120 to be positioned at an acute angle relative to the face 112 of the back member 102 and a display (not shown) of the electronic device. The first hinge 122 may fold such that the first support member 130 can be removably coupled to the first bracket 106 to retain the shade member 120 at the acute angle. In the exemplary embodiment, the pins 116 extending from the pin supports 114 of the first bracket 106 may be configured to fit within the holes 140 defined by the arcuate sections 138 of the rectangular member 136, and removably couple the first support member 130 to the first side bracket 106 through a snap fit.

In other embodiments, the first support member 130 may be removably coupled to the first side bracket 106 using magnets, adhesives, Velcro, or other similar means. The second support member 132 and second side bracket 108 may be removably coupled similar to the first support member 130 and first support bracket 106 to retain the shade member 120 at the acute angle. In at least one embodiment, the pin supports 114 and arcuate sections 138 on both the side brackets 106, 108 and the support members 130, 132 may be omitted and the support members 130, 132 may be directly removably coupled to the side brackets 106, 108.

The shade member 120 may also be positioned at an acute angle relative to the back 402 of the back member 102. A possible use of the mirror in this position includes, but is not limited, to the application of makeup. In the exemplary embodiment, the shade member is not retained in this position, allowing the mirror 302 to be held at a desired angle relative to a light source, camera, or any other feature on the back of the electronic device. In other embodiments, the shade member 120 may be retained in position by the support members 130, 132. The support members 130, 132 may be removably coupled to the side brackets 106, 108 using the methods described above. In at least one embodiment, a portion of the support members 130, 132 may be directly removably coupled to a portion of side brackets 106, 108.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. A multifunction accessory for an electronic device comprising:
a back member defining an aperture;
a first side bracket coupled to the back member;
a second side bracket coupled to the back member and positioned opposite the first side bracket;
a hinge mechanism connected to the back member between the first and second side brackets;
a shade member coupled to the hinge mechanism opposite the back member connection;
a first hinge connected to a first side of the shade member;
a first support member coupled to the first hinge opposite the shade member connection and removably coupled to the first side bracket;
a second hinge connected to a second side of the shade member and positioned opposite the first hinge; and
a second support member coupled to the second hinge opposite the shade member connection and removably coupled to the second side bracket.

2. The multifunction accessory of claim 1, further comprising a mirror coupled to the shade member.

3. The multifunction accessory of claim 1, wherein both the first and second side brackets further comprise at least one pin extending away from the back member, the first support member further comprises at least one hole configured to align with the at least one pin of the first side bracket, and the second support member further comprises at least one hole configured to align with the at least one pin of the second side bracket.

4. The multifunction accessory of claim 3, wherein the first and second support members are removably coupled to the first and second side brackets through a snap fit.

5. The multifunction accessory of claim 1, wherein the hinge mechanism comprises:
a first spacer;
a first pivot coupled to the first spacer and the back member;
a second spacer;
a second pivot coupled to the first spacer and the second spacer; and
a third pivot coupled to the second spacer and the shade member.

6. The multifunction accessory of claim 1, wherein the first hinge is configured to allow the first support member to lie on the shade member and the second hinge is configured to allow the second support member to then lie on top of the first support member.

7. The multifunction accessory of claim 6, wherein the first support member is removably coupled to the second support member.

8. The multifunction accessory of claim 7, wherein the first and second support members are removably coupled through a snap fit.

9. A multifunction accessory for an electronic device, comprising a single body, the single body comprising:
a back member defining an aperture and having a first and second side;
a first side bracket extending from the first side of the back member;
a second side bracket extending from the second side of the back member and positioned opposite the first side bracket;
a shade member extending from the back member between the first side bracket and the second side bracket;
a first hinge formed between the back member and the shade member;
a first support member extending from the shade member and removably coupled to the first side bracket;
a second hinge formed between the shade member and the first support member;
a second support member extending from the shade member opposite the first support member and removably coupled to the second side bracket; and
a third hinge formed between the shade member and the second support member.

10. The multifunction accessory of claim 9, further comprising a mirror coupled to the shade member.

11. The multifunction accessory of claim 9, wherein both the first and second side brackets further comprise at least one pin extending away from the back member, the first support member further comprises at least one hole configured to align with the at least one pin of the first side bracket, and the second support member further comprises at least one hole configured to align with the at least one pin of the second side bracket.

12. The multifunction accessory of claim 11, wherein the first and second support members are removably coupled to the first and second side brackets through a snap fit.

13. The multifunction accessory of claim 9, wherein the second hinge member is configured to allow the first support member to lie on the shade member and the third hinge is configured to allow the second support member to then lie on top of the first support member.

14. The multifunction accessory of claim 13, wherein the first support member is removably coupled to the second support member.

15. The multifunction accessory of claim 14, wherein the first and second support members are removably coupled through a snap fit.

16. The multifunction accessory of claim 9, wherein the first hinge is crimped to form:
a first spacer;
a first pivot adjacent the first spacer and the back member;
a second spacer;
a second pivot adjacent the first spacer and the second spacer; and
a third pivot adjacent the second spacer and the shade member.

17. A multifunction accessory for an electronic device, comprising:
a back member defining an aperture;
a plurality of pins extending from the back member;
a hinge mechanism connected to the back member;
a shade member coupled to the hinge mechanism opposite the back member connection;
a first hinge connected to a first side of the shade member;
a first support member coupled to the first hinge opposite the shade member connection and removably coupled to at least a first pin of the plurality of pins;
a second hinge connected to a second side of the shade member and positioned opposite the first hinge; and
a second support member coupled to the second hinge opposite the shade member connection and removably coupled to at least a second pin of the plurality of pins.

18. The multifunction accessory of claim 17, further comprising a mirror coupled to the shade member.

19. The multifunction accessory of claim 17, wherein the hinge mechanism comprises:
a first spacer;
a first pivot coupled to the first spacer and the back member;
a second spacer;
a second pivot coupled to the first spacer and the second spacer; and
a third pivot coupled to the second spacer and the shade member

20. The multifunction accessory of claim 17, wherein the first hinge is configured to allow the first support member to lie on the shade member and the second hinge is configured to allow the second support member to then lie on top of the first support member, and the first support member is removably coupled to the second support member through a snap fit.
